(19) United States
(12) Patent Application Publication
(10) Pub. No.: US 2025/0326900 A1
(43) Pub. Date: Oct. 23, 2025

(54) ELASTOMER COMPOSITES AND METHODS OF FABRICATION

(71) Applicant: Purdue Research Foundation, West Lafayette, IN (US)

(72) Inventor: Garam Kim, West Lafayette, IN (US)

(21) Appl. No.: 19/185,459

(22) Filed: Apr. 22, 2025

Related U.S. Application Data
(60) Provisional application No. 63/637,066, filed on Apr. 22, 2024.

(51) Int. Cl. C08J 5/04; B29C 70/22; B29C 70/54; B29K 83/00; B29K 307/04

(52) U.S. Cl. CPC C08J 5/042; B29C 70/22; B29C 70/541; B29K 2083/00; B29K 2307/04; B29K 2995/0046; C08J 2383/04

(57) ABSTRACT

Elastomer composites and methods for their fabrication. Such an elastomer composite includes a stretchable matrix of curable resin, and an elongate strand made up of one or more reinforcing fibers. The elongate strand is encapsulated within the matrix and extends from a first end to a second end along an axis of the stretchable matrix. The elongate strand defines a wavy pattern extending along the axis from the first end to the second end. The elastomer composite can be fabricated by forming the elongate strand into a wavy pattern extending along an axis from a first end to a second end, and encapsulating the elongate strand in the wavy pattern within the stretchable matrix of curable resin.

### CROSS-REFERENCE TO RELATED APPLICATIONS

This application claims the benefit of provisional U.S. Patent Application No. 63/637,066 filed Apr. 22, 2024, the contents of which are incorporated herein by reference.

### BACKGROUND OF THE INVENTION

The invention generally relates to elastomer composites and methods for their fabrication.

There is a significant commercial demand for flexible and stretchable materials in a wide range of industries, such as the aerospace, aviation, and underwater vehicle industries, as well as the soft robotics and biomedical device industries due to their great potential in numerous applications. Elastomeric polymers are often in these industries due to their unique bending and stretching properties. Despite these unique properties, elastomeric polymers are not commonly used for structural components due to their low stiffness and strength, as well as high sensitivity to cracking. To enhance the mechanical performance of elastomers, they are often combined with fiber reinforcement to create composites. These composites combine the flexibility of elastomers with added stiffness and strength, making them less prone to rupture.

Conventional methods for creating fiber-reinforced elastomer composites encompass the utilization of both continuous and discontinuous fibers. The traditional fiber-reinforced elastomer composite used continuous straight fibers as reinforcement, which allowed the composite to retain the flexibility of the elastomer. However, its stretchability was compromised because the straight fibers, along with the loading direction, resisted elongation when the elastomer composite was stretched. If the fiber is angled, for example, at a 45-degree orientation relative to the loading direction, it allows the composites to elongate, although the amount of elongation is limited. Also, continuous fiber reinforcement can lead to complex and labor-intensive fabrication processes of fiber reinforced elastomer composites, especially for intricate part geometries. In contrast, discontinuous fiber reinforcement that incorporates short fibers allows for easier manufacturing using extrusion or matrix transfer molding technologies. Conventional short fiber reinforced elastomer composites exhibit an increased modulus of elasticity and yield stress under tensile loading as the fiber volume fraction increases. However, the stretchability, as measured by the distance at failure during the tensile test, typically decreases with higher fiber volume fractions. Discontinuous fiber also provides additional stiffness and strength without sacrificing all stretchability, although its stiffness and strength are not as high as continuous fiber, and stretchability is significantly reduced compared to neat elastomer (i.e., an elastomer without reinforcing fibers). Furthermore, non-uniform fiber distribution and orientation during the composite fabrication process can also cause problems relative to uniformity and predictability. To visualize this, FIG. 1 represents an example of a conventional non-reinforced (“neat”) elastomer specimen under no load and under a tensile load. Although its stretchability is high, there is little stiffness to prevent cracking (failure) at higher loads. FIG. 2 represents a conventional straight fiber-reinforced elastomer specimen under no load and under a tensile load. In this example, although the stiffness provided by the reinforcing fiber is high and resists elongation leading to failure (e.g., cracking), the stretchability is very low. Thus, these two examples of conventional fiber-reinforced elastomer composites evidence limitations for obtaining both high stretchability and high stiffness/strength to prevent premature cracking or other failure resulting from excessive strain.

Therefore, it would be desirable if fiber reinforced elastomer composites were available that are capable of exhibiting improved combinations of stretchability and stiffness.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, elastomer composites and methods of fabricating elastomer composites.

According to a nonlimiting aspect, an elastomer composite includes a stretchable matrix of curable resin, and an elongate strand made up of one or more reinforcing fibers. The elongate strand is encapsulated within the matrix and extends from a first end to a second end along an axis of the stretchable matrix. The elongate strand defines a wavy pattern extending along the axis from the first end to the second end.

According to another nonlimiting aspect, a method of fabricating an elastomer composite includes forming an elongate strand comprising one or more reinforcing fibers into a wavy pattern extending along an axis from a first end to a second end, and encapsulating the elongate strand in the wavy pattern within the stretchable matrix of curable resin.

Technical aspects of elastomer composites and methods as described above preferably include the ability to exhibit improved combinations of stretchability and ultimate stiffness relative to conventional fiber reinforced elastomer composites.

These and other aspects, arrangements, features, and/or technical effects will become apparent upon detailed inspection of the figures and the following description.

### BRIEF DESCRIPTION OF THE DRAWINGS

FIG. 1 is a schematic representation of a conventional non-reinforced elastomer specimen (“coupon”) under non-loaded (left image) and tensile loaded (right image) conditions.

FIG. 2 is a schematic representation of a conventional straight fiber-reinforced elastomer specimen under non-loaded (left image) and tensile loaded (right image) conditions.

FIG. 3 is a schematic representation of a wavy patterned fiber-reinforced elastomer specimen according to a nonlimiting embodiment of the present invention under non-loaded (left image) and tensile loaded (right image) conditions.

FIG. 4 is a schematic representation of a process of fabricating a wavy patterned fiber-reinforced elastomer according to a first embodiment of the invention.

FIG. 5 is a schematic representation of a process of fabricating a wavy patterned fiber-reinforced elastomer according to a second embodiment of the invention.

FIGS. 6A-6E are images of different test specimens prepared for investigations leading to the present invention. FIG. 6A depicts a specimen with a single fiber reinforcing strand (single-tow specimen) having a wavy pattern characterized by a substantially repeating wave form within the gauge length of the specimen. FIG. 6B depicts a single-tow specimen having a wavy pattern characterized by a wave form within the gauge length of the specimen that was designed to exhibit a lower elongation level when the tow becomes straight compared to the wavy pattern of FIG. 6B. FIG. 6C depicts a specimen with two fiber reinforcing strands (double-tow specimen) combined to define the wavy pattern of FIG. 6A within the gauge length of the specimen. FIG. 6D depicts a double-tow specimen in which two tows are arranged to define a symmetric double wavy pattern within the gauge length of the specimen. FIG. 6E is a comparison test specimen that was formed entirely of elastomer without any fiber reinforcing strands for use as a baseline comparison.

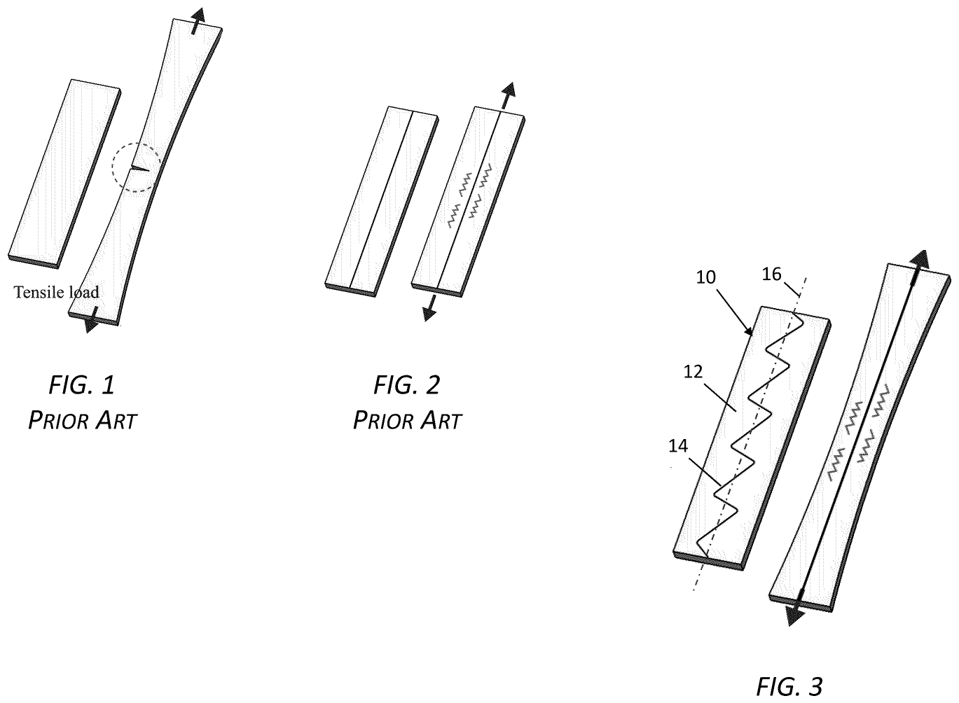

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded as aspects of the invention, including certain but not necessarily all of the aspects and alternatives described in the detailed description.

The following describes elastomer composites and methods for their fabrication. Although the elastomer composites will be described hereinafter in reference to certain test specimens (“coupons”) and methods represented in the drawings, it will be appreciated that the teachings of the invention are more generally applicable to a wide variety of types and/or of forms, shapes, and sizes of fiber-reinforced elastomer composite materials.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

To address the challenge of achieving both the stretchability of elastomers and the structural integrity comparable to continuous fibers in fiber-reinforced elastomer composites, the present invention provides an approach involving the use of patterned fiber reinforcement, such as wavy or zig-zag patterns, within elastomer composites. Under loading conditions, the composites are allowed to stretch until their fiber reinforcement becomes straight. At this point, the fibers begin to resist elongation, imparting stiffness and strength to the composite. This technology allows precise control of elongation of the composite by manipulating the fiber pattern, preventing the composite from reaching its elongation at failure. Furthermore, fiber reinforcement can effectively hinder crack propagation in the elastomer composite, addressing the vulnerability of crack propagation from existing cracks in the elastomer. These capabilities allow the composite to overcome the limitation of the elastomer while taking advantage of the benefits offered by fiber-reinforced composites.

Turning now to the nonlimiting embodiments represented in the drawings, FIG. 3 schematically represents a fiber-reinforced elastomer composite 10 comprising an elastic (stretchable) matrix 12 containing a fiber reinforcement of at least one elongate reinforcing strand 14 configured to have a wavy pattern (wavy patterned) according to a nonlimiting embodiment of the present invention. The composite 10 is represented in FIG. 3 in both non-loaded (left image) and tensile loaded (right image) conditions. Though the composite 10 is shown with a generally thin rectangular shape, it is understood that the shape of the composite 10 can be provided in an essentially unlimited number of shapes and sizes as desired to meet various design requirements for a given product. The reinforcing strand 14 extends in a wavy pattern generally along an axis 16 of the composite 10. The reinforcing strand 14 may be made up of one or more reinforcing fibers. Nonlimiting examples of reinforcing fibers that can be used include carbon fibers, glass fibers, aramid fibers, basalt, and asbestos, although other types of reinforcing fibers could be used. A particular but nonlimiting example of the reinforcing strand 14 is formed of a carbon fiber tow that has a large number of individual reinforcing fibers gathered together loosely in the shape of a long, non-braided ribbon or rope. However, other types and forms of reinforcing strands 14 could be used. The reinforcing strand 14 is relatively long (e.g., centimeter to meter lengths and longer) and extends in a substantially continuous length between opposite first and second ends of the composite 10. The elastomer for the matrix 12 preferably is formed of a curable resin for ease of manufacture so that it can be easily poured and/or molded and then cured to maintain its molded form factor. A particular but nonlimiting example of a suitable elastomer is a silicone-based elastomer (e.g., silicone rubber), although other types of curable resins and curable elastomeric materials could be used.

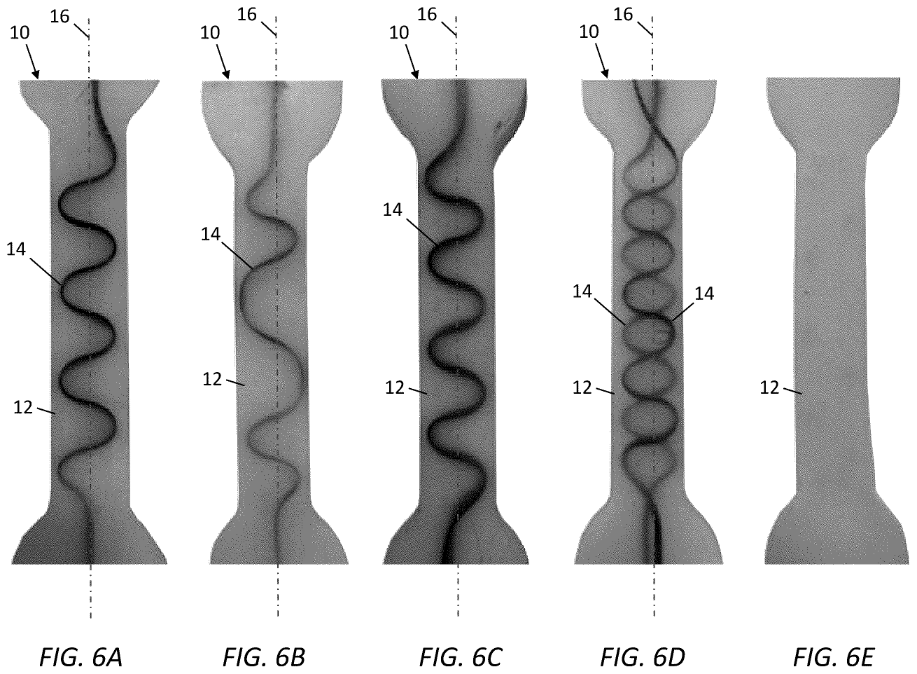

The wavy pattern of the reinforcing strand 14 repeats along the length of the strand 14 from the first end to the second end of the composite 10. The wavy pattern may have any repeating wavy shape that has at least one amplitude. For example, the wavy pattern may have an angular zig-zag pattern such as the saw-tooth patterns represented in FIGS. 3-5, a more curvy, generally sinusoidal wave-like pattern as shown in FIGS. 6A-6C, or another type or shape of repeating, undulating/oscillating pattern that extends along the axis 16 and forms a plurality of successive peaks and valleys. The wavy pattern may also include two more different shapes of undulations along the same reinforcing strand 14 and/or multiple reinforcing strands 14 with different wavy patterns. For example, FIGS. 6A-6D show a few nonlimiting examples of wavy pattern configurations utilizing one or more elongate reinforcing strands 14 implemented in test specimens each having a “dog bone” shape that includes a “gauge length” characterized by a uniform thickness and width. In FIG. 6A, the composite 10 has a single-tow carbon fiber reinforcing strand 14 (single-tow specimen) that defines what is described herein as a substantially periodic sinusoidal wavy pattern that extends axially throughout the gauge length of the specimen with a substantially constant period and amplitude. In FIG. 6B, the composite 10 has a single-tow carbon fiber reinforcing strand 14 (single-tow specimen) that defines what is described herein as a nonperiodic sinusoidal wavy pattern characterized by a wave form within the gauge length of the specimen that was sinusoidal-type with a substantially constant amplitude but different period along its length to exhibit a lower elongation level when the tow becomes straight compared to the wavy pattern of FIG. 6B. In FIG. 6C, the composite 10 has two fiber reinforcing strands (double-tow specimen) combined to define substantially the same periodic sinusoidal wavy pattern as FIG. 6A within the gauge length of the specimen. In FIG. 6D, the composite 10 has two fiber reinforcing strands (double-tow specimen) that each extend axially throughout the gauge length of the specimen with a substantially constant period and amplitude. The strands are mirrored symmetrically about the axis 16 of the specimen (e.g., one of the strands 14 is offset by half of a wavelength from the other strand) to define what is described herein as a symmetric double-sinusoidal wavy pattern within the gauge length of the specimen. Other shapes and forms of the wavy pattern of the reinforcing strand(s) 14 could be implemented.

Preferably, a wavy pattern selected for a composite 10 has an amplitude that ensures that, when the stretchable matrix 12 is stretched under tensile load along the axis 16, the reinforcing strand(s) 14 are completely straightened before the stretchable matrix 12 itself elongates enough to reach its failure strain. This ensures that the reinforcing strand(s) 14 can provide added tensile strength to the overall composite 10 prior to the matrix 12 failing, for example by forming and/or propagating a crack. In this way, the reinforcing strand 14 allows the matrix 12 to stretch relatively easily but also provides added mechanical tensile strength (e.g., “stiffness”) to the composite 10 to provide added strength by fully engaging the strength of the reinforcing strand(s) 14 before reaching the failure strain (elongation) of the matrix 12 in which it is embedded. Of course, the exact dimensions and shapes of the reinforcing strand(s) 14 needed to accomplish this will vary depending on the specific materials used for the stretchable matrix 12 and the overall shape of the composite 10, as well as other possible factors. An advantage of using the wavy-patterned reinforcing strands 14 is that the exact shape and arrangement of the wavy pattern can be tailored to meet a wide variety of different design constraints, such as material, shape, and use parameters.

This technology holds high potential for various industries. Inflatable structures, such as space habitats, space or marine suits, and inflatable robots, can maintain their shape after inflation by controlling the elongation of the composite 10. For soft robotics, more complex movements can be designed and achieved by customizing the local fiber patterns. Additionally, it can be applied in wearable devices, apparel, and morphing surface structures that are easily stretchable yet less prone to tearing.

Embedding straight fibers in an elastomeric material is relatively easy, but maintaining a specific fiber pattern in an elastomeric matrix during curing of the elastomer requires additional complexity. Proper bonding between the fiber reinforcements and matrix is also important. The mechanical properties of fiber-reinforced elastomers primarily rely on the adhesion between the fiber and the elastomer matrix. However, achieving good fiber-elastomer adhesion remains a significant challenge in the fabrication process. In investigations leading to the present invention, different methods for fabricating patterned fiber-reinforced elastomer composites 10 were tested. Additionally, tensile test specimens of the wavy-patterned fiber-reinforced elastomer composites 10 in FIGS. 6A-6D were prepared and tested to study its behavior under loading conditions. The stiffness, strength, failure mechanism, and sensitivity to a pre-made crack of the experimental wavy-patterned fiber-reinforced elastomer composites 10 were investigated and analyzed. The methodology of these investigations is described below.

In the fabrication of specimens of the wavy-patterned fiber-reinforced elastomer composites 10, reinforcing strands 14 formed of Hexcel AS4-GP 3K carbon fiber tows were used as the fiber reinforcement, while Smooth-On Dragon Skin™ 30 silicone was used for the elastomer matrix 12. Dragon Skin™ 30 has a pot life of forty-five minutes and requires sixteen hours for full curing.

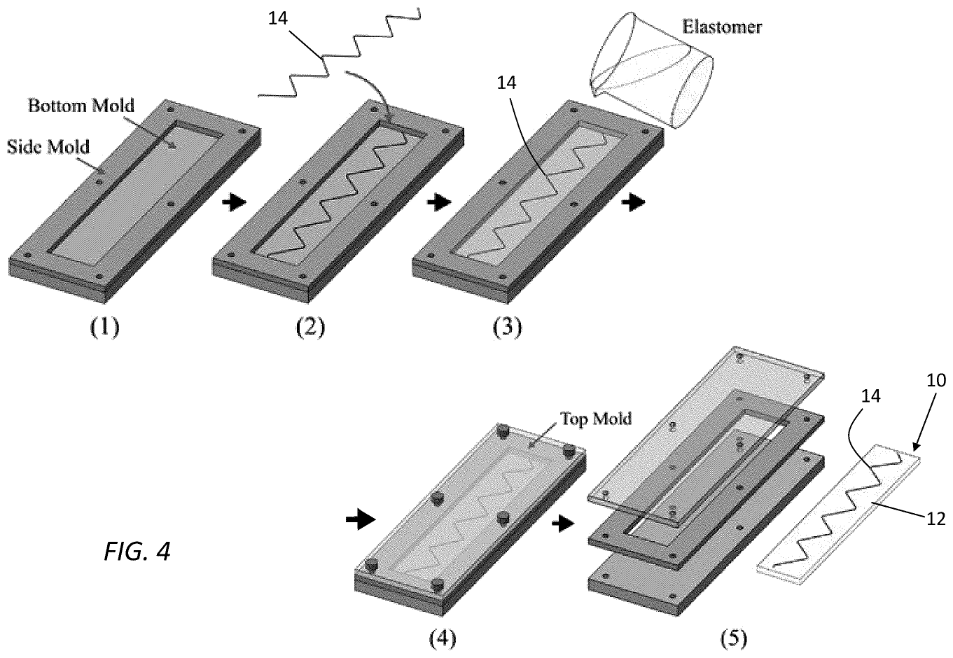

Turning now to FIG. 4, in one nonlimiting example method of forming the elastomer composite 10, the fabrication of the wavy-patterned fiber-reinforced elastomer composite 10 involved casting a specimen (coupon) in a mold comprising bottom, side, and top sections. Initially, a carbon fiber tow was impregnated with silicone using an impregnation roller in a silicone bath. The carbon fiber tow was manually dipped in the silicone bath and rubbed back and forth against the impregnation roller to ensure thorough filling of the gap between the reinforcing strand(s) 14 with the silicone matrix 12, facilitated by the sheer force between the reinforcing strand(s) 14 and roller. FIG. 4 represents five steps of a fabricating process used to produce test specimens of wavy-patterned fiber-reinforced elastomer composites 10. As labeled in FIG. 4, the five steps included (1) assembling the bottom and side sections of a mold, (2) placing the reinforcing strand 14 inside the mold, (3) pouring the silicone into the mold and subjecting the mold to a vacuum chamber to remove any air bubbles, (4) installing a top mold to control the thickness of the composite 10, and after curing (5) disassembling the mold to demold the wavy-patterned fiber-reinforced elastomer composite 10.

Another nonlimiting example method of forming the elastomer composite 10 was used to overcome difficulties encountered with the method of FIG. 4. In this method, a top cover with needle holes was designed and fabricated. The impregnated reinforcing strand 14 was shaped into the desired wavy pattern using needles installed on the top cover. Subsequently, the silicone was poured into the bottom and side mold assembly. The top cover, now with the shaped reinforcing strand 14, was installed onto the mold assembly. Once the reinforcing strand 14 had settled, the needles were gently removed. The entire mold assembly was then placed into a vacuum chamber to eliminate any air bubbles or voids inside the specimen. If necessary, additional silicone was poured to fill any remaining voids (needle holes). Following complete curing of the silicone, the mold was disassembled and the fabricated specimen was extracted. As a result of this alternative fabrication process, the wavy-patterned reinforcing strand 14 was positioned approximately in the middle of the specimen's thickness instead of being exposed on one or the other side of the composite 10, and the absence of visible air bubbles or voids inside the specimen was confirmed. This method ensured the stability and accuracy of the placement of the reinforcing strands 14 within the composite 10.

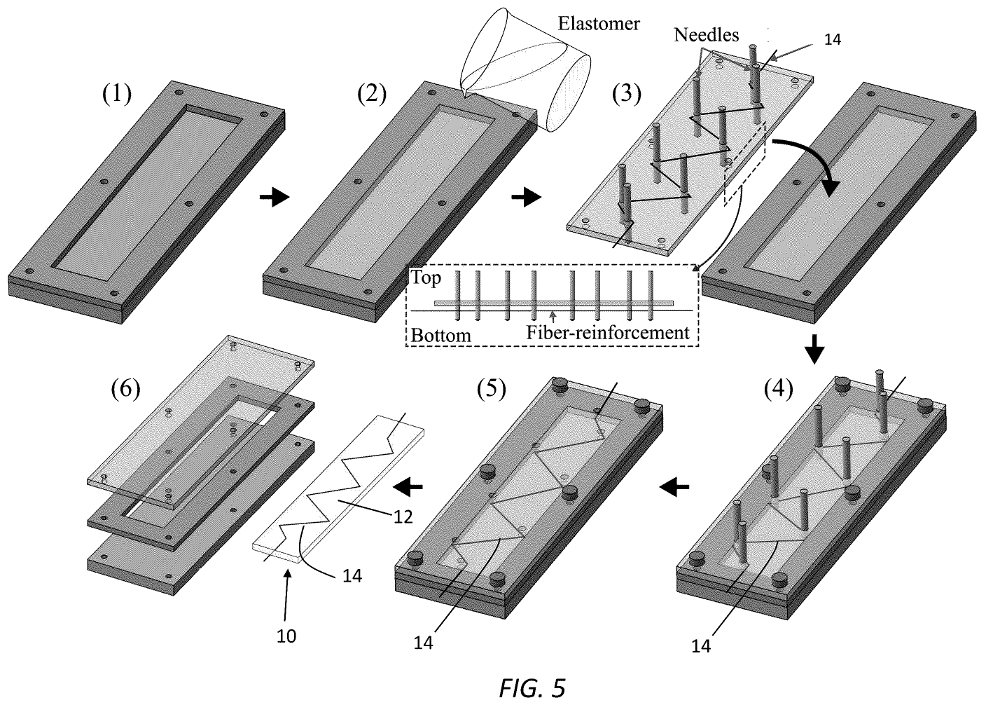

FIG. 5 represents six steps of the above-described alternative fabricating process. As labeled in FIG. 5, the six steps included (1) assembling bottom and side mold sections of a mold, (2) pouring the silicone into the mold and subjecting the mold to a vacuum chamber to remove any air bubbles, (3) preparing the top cover with needles and placing the wavy-patterned reinforcing strand 14 using the needles, (4) installing a top cover of the mold on the side mold section, (5) removing the needles and subjecting the mold to a vacuum chamber to remove any air bubbles if necessary, and (6) disassembling of the mold to demold the wavy-patterned fiber-reinforced elastomer composite 10.

Tensile tests of the specimens shown in FIGS. 6A-6D were conducted to evaluate effectiveness of the elastomer composites 10 and methods. Three different types of tensile tests were performed to comprehensively evaluate the mechanical behavior of the wavy-patterned fiber reinforced elastomer composite 10 under loading conditions. The first test was a “traditional” tensile test, wherein the test specimens were elongated with a constant rate of 20 mm/min until failure, enabling the determination of maximum stress and elongation. The test specimens depicted in FIGS. 6A through 6D were evaluated along with a comparison test specimen (FIG. 6E) formed entirely of the same elastomer as the test specimens.

Elastomeric materials are renowned for their capacity to undergo substantial elongation; however, they are also recognized for their susceptibility to cracks. Given this context, the investigations were intended to evaluate the influence of wavy-patterned reinforcing strand 14 on enhancing crack sensitivity. As such, tests were also conducted on the test specimen of FIG. 6A and the comparison test specimen of FIG. 6E each with a pre-existing crack having a length of 3.175 mm intentionally created at the midpoint of their gauge lengths. The test conditions were otherwise identical to the traditional tensile test.

The test specimens of FIGS. 6A-6E were tested using a roller grip test fixture. During the tensile test, the specimens of FIGS. 6A-6D containing the wavy-patterned reinforcing strands 14 showed a unique behavior. Although there were differences among the test specimens, they all showed common behavior and failure mechanisms under tensile loading. Initially, the reinforcing strands 14 having a wavy pattern (FIGS. 6A-6D) initially exhibited similar behavior to that of the comparison test specimen of FIG. 6E. However, as their reinforcing strands 14 gradually straightened, the test specimens of FIGS. 6A-6D experienced a rapid increase in load, indicating an increase in composite stiffness. As their reinforcing strands 14 reached a fully straightened state, the load continued to rise until the reinforcing strand 14 broke, ultimately leading to the failure of the test specimen. In contrast, the comparison test specimen (FIG. 6E) showed a low stiffness and high elongation of 217% before failure at 14.8 MPa.

The single-tow elastomer composite of FIG. 6A with the periodic sinusoidal wavy pattern had a similar stiffness until reaching approximately 50% elongation. As the reinforcing strand 14 straightened, the test specimen experienced a significant increase in load. The specimen of FIG. 6A had an average maximum stress of 51.7 MPa, which was 249% higher compared to the comparison test specimen of FIG. 6E. The average elongation at failure was 117%, representing a 46% reduction compared to the comparison test specimen. The elongation observed in the test specimen exceeded the designed elongation of the specimen of FIG. 6A, which was 67%. It was observed that the elongation was not solely attributed by the wavy-patterned reinforcing strand 14 but also by the roller grip test fixture.

The double-tow specimen of FIG. 6B with the nonperiodic sinusoidal wavy pattern had an average maximum stress of 53.1 MPa, which was similar to the specimen of FIG. 6A. The overall behavior under tensile loading was similar to the specimen of FIG. 6A, but the specimen of FIG. 6B showed an earlier load increase, leading to more quickly reaching the maximum stress and failure during elongation. The average elongation at break was 85%, exceeding the designed elongation of 51% due to the additional elongation from the roller grip test fixture.

The single-tow specimen of FIG. 6C with the periodic sinusoidal wavy pattern showed an increase in load at a similar elongation to the specimen of FIG. 6A but with a higher increment, resulting in an average maximum stress of 99.4 MPa, a substantial 92% increase compared to the specimen of FIG. 6A. The elongation at break was 122%, which was similar to the specimen of FIG. 6A.

The double-tow specimen of FIG. 6D with the double-sinusoidal wavy pattern had a higher stiffness from the outset, resulting in a stress at 50% elongation (8.7 MPa) that was significantly higher than both the specimens of FIG. 6A (3.9 MPa) and FIG. 6C (5.5 MPa). The specimen of FIG. 6D reached an average maximum stress of 86.8 MPa, a 68% increase compared to the specimen of FIG. 6A. The average maximum stress of the specimen of FIG. 6D was lower than that of the specimen of FIG. 6C, despite having an equivalent amount of fiber in the specimen. The average elongation at failure of the specimen of FIG. 6D (122%) was similar to that of the specimens of FIGS. 6A and 6C.

Crack sensitivity of the specimens was evaluated by comparing the comparison test specimen (FIG. 6E) and the test specimen of FIG. 6A with pre-existing cracks as noted above. The test results indicated that the elastomer test specimen containing the pre-existing crack showed a substantial reduction in maximum stress, measuring 4.9 MPa. It represented a significant 67% decrease compared to the elastomer test specimen without the pre-crack. The average elongation at break decreased to 119%, marking a 45% reduction compared to the elastomer test specimen without the pre-crack. The test results affirmed that the pre-existing crack induced premature failure in the elastomer test specimen. In the case of the specimen of FIG. 6A, the average maximum load of test specimens with the pre-crack measured 51.73 MPa. This represented a minor 1.9% reduction compared to the specimen of FIG. 6A without the pre-crack. The elongation at break measured 117%, indicating a 5.4% increase compared to the elongation at failure of the specimen of FIG. 6A without the pre-crack. The test results showed that there were no noticeable differences in maximum stress and elongation at failure between the specimen of FIG. 6A with and without a pre-existing crack.

It was observed that when the elastomer matrix 12 failed (at elongation at failure), the fiber-reinforced elastomer composite 10 also failed. Without wishing to be bound by theory, it appeared that once the bonding between the reinforcing strand(s) 14 and the elastomer of the matrix 12 was compromised, the reinforcing strands 14 quickly experienced failure. This implies that even with the presence of fiber, the elastomer still fails at elongation at break. As the elastomer fails, the bond between the reinforcing strands 14 and elastomer matrix 12 breaks, resulting in fiber reinforcement failure and subsequent test specimen failure. Therefore, in the design of wavy-patterned fiber-reinforced elastomer composites, it is typically preferred that the point at which the reinforcing strand 14 becomes completely straight occurs at an elongation value lower than that of the elastomer's elongation at failure. Failing to achieve this alignment typically results in the elastomer failing prematurely, subsequently leading to fiber failure. Thus, in the wavy-patterned fiber-reinforced elastomer composites 10, the wavy shape of the reinforcing strands 14 is preferably selected such that it becomes completely straight prior to the elongation of the elastomer matrix 12 at failure in order to provide sufficient strength and stiffness to prevent failure of the composite 12.

The wavy-patterned fiber-reinforced elastomer composites 10 and methods disclosed herein combine the stretchability inherent to elastomers with the stiffness and strength characteristics typically associated with continuous fibers upon reaching the desired elongation. This enables the material to transition from elongation-driven behavior to a load-resisting structural component before the elastomer fails. This technology is a promising candidate for applications such as surface morphing in aerospace, automobiles, underwater vehicles, and adaptable structures. The test results evidenced elongation capabilities and mechanical strength that surpassed those of traditional elastomers. Moreover, the manipulation of wavy patterns and fiber content exhibited during testing demonstrated the versatility of this composite in achieving different performance outcomes.

The wavy-patterned fiber reinforced elastomer composites 10 have the stretching capability of their elastomer matrix 12 and also, when they reach the target elongation when their reinforcing strands 14 become straightened, they have the stiffness and strength of the reinforcing strands 14. Different wavy patterns can be used to provide different elongation ranges, and the amount of fiber changes the stiffness and strength of the elastomer composites. In the pre-cracked tensile tests, the wavy-patterned fiber-reinforced elastomer composite showed reduced sensitivity to pre-existing cracks, unlike the premature failure observed in the comparison test specimen.

As previously noted above, though the foregoing detailed description describes certain aspects of one or more particular embodiments of the invention, alternatives could be adopted by one skilled in the art. For example, the elastomer composites 10 and their matrices 12 and reinforcing strands 14 could differ in appearance and construction from the embodiments described herein and shown in the drawings, and various materials could be used in the fabrication of the elastomer composites 10 and/or their matrices 12 and reinforcing strands 14. As such, and again as was previously noted, it should be understood that the invention is not necessarily limited to any particular embodiment described herein or illustrated in the drawings.

1. An elastomer composite comprising:
a stretchable matrix of curable resin; and
an elongate strand comprising one or more reinforcing fibers, the elongate strand encapsulated within the matrix, the elongate strand extending from a first end to a second end along an axis of the stretchable matrix and defines a wavy pattern extending along the axis from the first end to the second end.

2. The elastomer composite of claim 1, wherein the wavy pattern has an amplitude selected to ensure that, when the stretchable matrix is stretched under tensile load along the axis, the elongate strand within the stretchable matrix becomes completely straight a first elongation that is lower than a second elongation at which the stretchable matrix fails.

3. The elastomer composite of claim 1, wherein the wavy pattern has a generally sinusoidal shape.

4. The elastomer composite of claim 1, wherein the wavy pattern has a generally angled zig-zag shape.

5. The elastomer composite of claim 1, wherein the elongate strand comprises a fiber tow.

6. The elastomer composite of claim 1, wherein the elongate strand comprises a plurality of fiber tows.

7. The elastomer composite of claim 5, wherein the fiber tow or tows are carbon fiber tows.

8. The elastomer composite of claim 1, wherein the stretchable curable resin comprises a silicone-based elastomer.

9. The elastomer composite of claim 1, further comprising a second elongate strand comprising one or more reinforcing fibers and encapsulated within the matrix, wherein the first elongate strand and the second elongate strand form a symmetric double wavy pattern extending along the axis.

10. A method of fabricating an elastomer composite, the method comprising:
forming an elongate strand comprising one or more reinforcing fibers into a wavy pattern extending along an axis from a first end to a second end; and
encapsulating the elongate strand in the wavy pattern within a stretchable matrix of curable resin.

11. The method of claim 10, wherein the step of encapsulating comprises disposing the elongate strand in a medial portion of a thickness of the stretchable matrix such that the elongate strand is not exposed on either a bottom surface or top surface of the stretchable matrix.

12. The method of claim 10, wherein the step of disposing comprises wrapping the elongate strand in a wavy pattern around a plurality of forms, forming the stretchable matrix around the form and the wrapped elongate strand, and removing the form from the matrix when the stretchable matrix is set sufficiently to maintain the elongate strand in the wavy pattern.

13. The method of claim 12, wherein the forms comprise pins and/or needles.

14. The method of claim 10, wherein the step of forming an elongate strand comprises impregnating the strand with a curable resin prior to the encapsulating step.

15. The method of claim 10, wherein the elongate strand comprises a fiber tow.

16. The method of claim 15, wherein the elongate strand comprises a carbon fiber tow.

17. The method of claim 10, wherein the curable resin comprises a silicone-based elastomer.
